(19) United States
(12) Patent Application Publication
(10) Pub. No.: US 2008/0013046 A1
(43) Pub. Date: Jan. 17, 2008

(54) Molds for progressive lenses

(76) Inventors: Dan Katzman, Givat Ela (IL); Yuval Carmon, Quiryat Tivon (IL)

Correspondence Address: PEARL COHEN ZEDEK LATZER, LLP, 1500 BROADWAY 12TH FLOOR, NEW YORK, NY, 10036, US

(21) Appl. No.: 11/484,602

(22) Filed: Jul. 12, 2006

(51) Int. Cl. G02C 7/06; B29C 33/00

(52) U.S. Cl. 351/169; 249/117; 249/160

(57) ABSTRACT

Embodiments of the present invention provide progressive molds including an inner progressive zone having one or more progressive optical properties, an outer bevel zone, and a transition zone in between the progressive and bevel zones to form a generally smooth transition between the progressive zone and the bevel zone.

### FIELD OF THE INVENTION

The present invention relates to molds for castes of optical elements, for example, ophthalmic lenses and semi-finished blanks for ophthalmic lenses.

### BACKGROUND OF THE INVENTION

Molds for producing optical elements, for example, progressive lenses or semi-finished blanks (SFBs) for progressive lenses, are known in the art. Such molds conventionally include a surface topography corresponding to desired optical properties, for example, a gradually increasing radius of curvature may result in a lens having spatially progressive optical properties. The mold surface may be designed using software capable of generating a surface with progressive optical properties. The software may calculate and prepare a mold surface file, taking into consideration various manufacturing aspects, for example, geometric measurements of the desired castes that may be formed using the mold, blocking tools, machining parameters, etc. The mold surface file may be sent to a mold generator, which may physically produce molds having a surface corresponding to the surface file. The molds may be used to form castes, for example, progressive lenses or blanks for progressive lenses, having the desired surface topography.

Reference is made to FIG. 1, which schematically illustrates a cross-sectional side view of a conventional progressive mold 10 and a thin film 60 positioned for casting. A top surface 15 of progressive mold 10 may include a progressive zone 30 having a progressive surface 32, and a bevel zone 40 having a bevel surface 42. A boundary point 43 may represent a point along the boundary between progressive zone 30 and bevel zone 40. A vertical axis 11 may be defined with an origin at the deepest point of mold surface 15, relative to a horizontal axis 12, which may be a center point 50. Horizontal axis 12 may also be defined with an origin at the deepest point of mold surface 15. Progressive zone 30 may be an inner region of surface 15 and may be centered about vertical axis 11. Progressive surface 32 may have an optically progressive surface topography, for example, a generally concave surface of varying concavity. For example, progressive surface 32 may have a relatively steep region 35 and a relatively shallow region 33.

Bevel surface 42 may be a generally flat surface along a periphery of mold 10 that surrounds progressive zone 30. Bevel surface 42 may have a substantially constant height relative to horizontal axis 12.

The width of bevel zone 40, or a corresponding region of a surface caste from progressive mold 10, may vary due to the varying steepness of progressive surface 32. Bevel zone 40 may have a region 24, adjacent to steep progressive region 35 and a region 34, adjacent to shallow progressive region 35. Since progressive zone 30 is centered at vertical axis 11, the radius, r₁, (relative to axis 11) at which steep progressive region 35 may reach the height of bevel surface 42 is smaller than the radius, r₂, at which shallow region 33 may reach the height of bevel surface 42. Thus progressive surface 32 may be asymmetric about vertical axis 11, resulting in an asymmetric bevel zone 40 of varying width. For example, region 24 may be wider than region 34.

Thin film 60 may be a thin lens having two surfaces, for example, a top surface 62 and a bottom surface 64. Top surface 62 and bottom surface 64 may both be spherical and may have the same curvature at corresponding locations. Thin film 60 may be positioned on progressive mold 10 prior to the casting process. A gasket may secure thin film 60 and progressive mold 10 during casting. A spherical mold 80 may hermetically seal one end of gasket 90.

The casting material, for example, plastic, may be poured onto thin film 60 and mold 10. Thin film 60 may become engulfed by the casting material, such that there may be no spacing between thin film 60 and the casting material. Thin film 60 may be made of materials such as, plastics, photo chromatic materials, polarized materials or any other suitable material.

Due to the above described asymmetries, progressive mold 10 may produce castes with uneven thickness. For example, if the width of bevel zone 40 is not constant and thin film 60 is spherical and centered along vertical axis 11, the relative spacing between thin film 60 and progressive zone 30 may vary. For example, the distance between thin film 60 and boundary point 43 adjacent to the relatively wider region 24 of bevel zone 40 may be smaller than the distance between thin film 60 and boundary point 43, adjacent to the relatively narrow region 34 of bevel zone 40.

If a caste has substantially uneven thickness, the thin film 60 may become exposed, for example, along the back surface of the caste during a tooling process. For example, when region 24 of bevel zone 40 is very wide and bevel zone 40 extends close to vertical axis 11, at which thin film 60 is centered, thin film 60 may contact mold 10, for example, at boundary point 43. In such cases, casting material may not penetrate the area where bevel zone 40 and thin film 60 are in contact. Thus, the casting material may not fully engulf thin film 60, which may be exposed at the caste surface, instead of being fully embedded under the caste surface.

A need exists for ophthalmic molds that form castes with areas of substantial uniform thickness.

### SUMMARY OF THE INVENTION

Embodiments of the present invention provide progressive molds that may be used to form castes with substantially uniform thickness. Embodiments of the present invention provide progressive molds that may have a smoother surface and may be more symmetric than conventional molds.

A mold surface according to some embodiments of the invention may include three zones, each having surface regions with a different surface topography. The three zones may include an inner progressive zone, an outer bevel zone, and a transition zone between the progressive and bevel zones. The progressive zone may have a progressive surface with spatially progressive topography corresponding to desired progressive optical properties. By virtue of the transition zone as described herein, the bevel surface of the bevel zone according to embodiments of the invention may have a substantially constant height and a substantially constant width, regardless of the properties of the progressive zone. The two zones may be concentric, for example, about the same axis, for example, a vertical axis originating at a center point of the mold.

According to embodiments of the invention, the transition zone may include a transition surface that may form a smooth transition from the variable curvature of the progressive surface to the flatness of the bevel surface. The transition surface may be less steep, on the average, than the progressive surface. This condition may provide a gradual transition between the progressive zone and the bevel zone.

According to some embodiments of the invention, once the progressive zone is designed, for example, using methods as are known in the art, and a desired bevel width is selected, the transition zone may be designed. For example, the transition surface may reflect an interpolation between the outermost curvature of the progressive surface and the generally flat bevel surface.

According to some embodiments of the invention, a caste, for example, a progressive lens, a SFB, or any other caste, may be produced using a progressive mold according to embodiments of the invention. Embodiments of the invention may provide a progressive caste having substantially constant thickness along the outer edge of the caste. A front surface of the caste may include an imprint of a portion of a mold surface. The front surface of the caste may include a progressive caste zone and a transition caste zone. The progressive caste zone and transition caste zone may be substantially concentric about a common axis. The progressive caste zone may include an inner zone of the caste surface having one or more progressive optical properties, and the transition caste zone may surround the progressive caste zone.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a schematic, side view, cross-sectional, illustration of a conventional progressive mold and a thin film positioned for a conventional casting process;

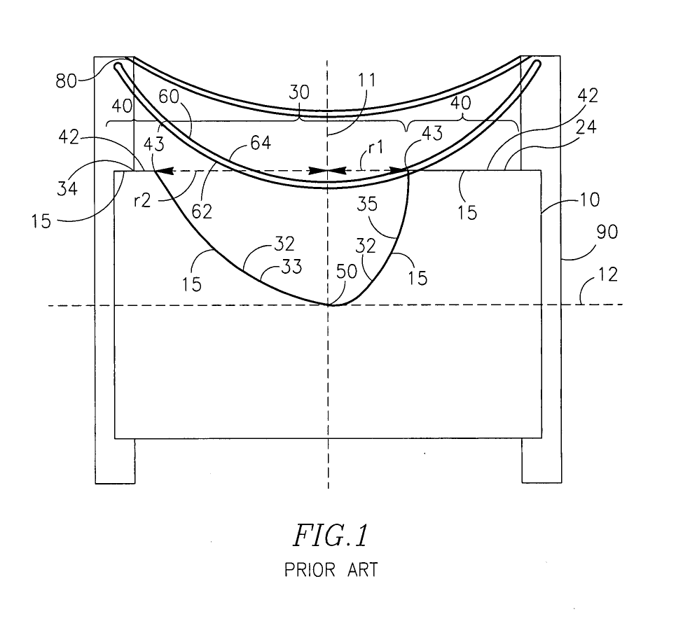

FIG. 2 is a schematic, side view, cross-sectional, illustration of a progressive mold according to an embodiment of the invention;

FIG. 3 is a schematic, top view, illustration of the progressive mold of FIG. 2; and

FIG. 4 is a schematic, side view, cross-sectional, illustration of a caste produced from a progressive mold according to an embodiment of the invention.

It will be appreciated that for simplicity and clarity of illustration, elements shown in the drawings have not necessarily been drawn accurately or to scale. For example, the dimensions of some of the elements may be exaggerated relative to other elements for clarity or several physical components included in one functional block or element. Further, where considered appropriate, reference numerals may be repeated among the drawings to indicate corresponding or analogous elements.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well-known features may be omitted or simplified in order not to obscure the present invention. Similar reference numerals refer to similar elements of the invention.

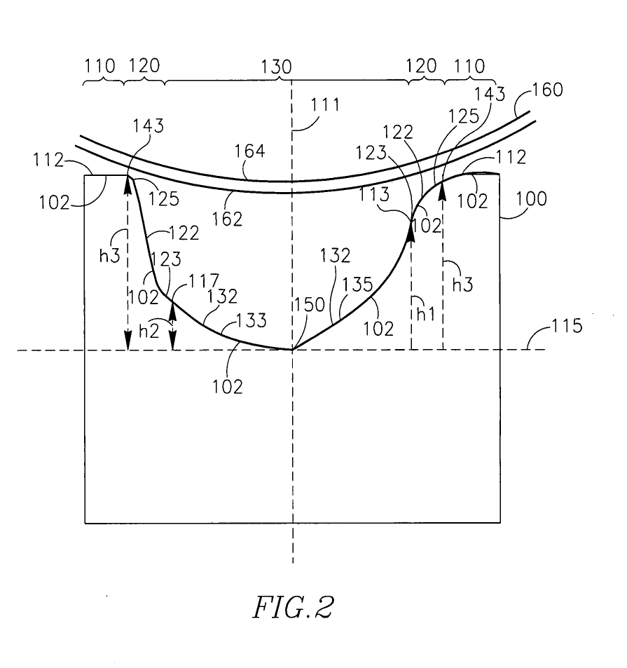

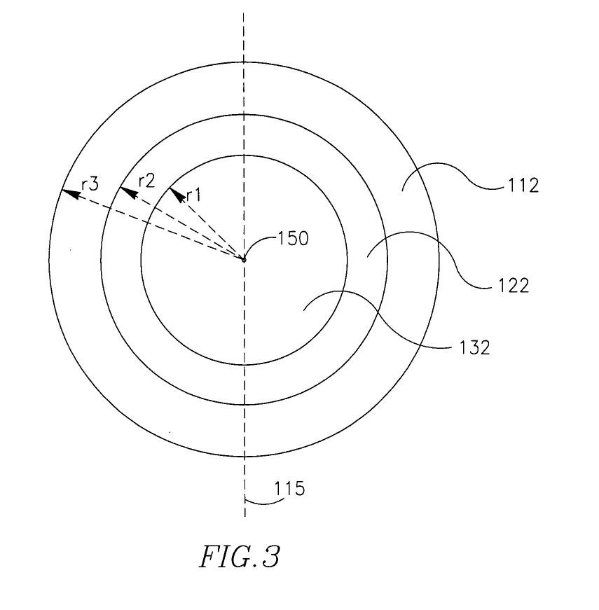

Reference is made to FIG. 2 and FIG. 3, which schematically illustrate a cross-sectional side view and top view, respectively, of a progressive mold 100, according to an embodiment of the invention. A top surface 102 of progressive mold 100 may be hereinafter referred to as mold surface 102. A center point 150 of progressive mold 100 may be defined as the deepest single point of progressive surface 132 relative to a horizontal axis 115 of mold 100. A vertical axis 111 maybe defined at center point 150.

Mold surface 102 may include an inner progressive zone 130 having a progressive surface 132 with progressive optical properties and an outer beveled zone 110 having a bevel surface 112. Progressive surface 132 may have a generally concave surface with varying concavity corresponding to desired progressive optical properties. Progressive zone 130 may have a relatively steep region 135 and a relatively shallow region 133.

Bevel surface 142 may be a generally flat surface along a periphery of mold 100 that surrounds progressive zone 130. Bevel surface 142 may have a substantially constant height relative to horizontal axis 115.

According to embodiments of the invention, mold 100 may include a transition zone 120, in between progressive zone 130 and bevel zone 110. Transition zone 120 may have a transition surface 122 that may provide a smooth transition between the variable curvature of progressive surface 132 at its outer boundary, and the generally level bevel surface 112 at its inner boundary. Transition zone 120 may have an inner edge 123 that borders the outer boundary of progressive zone 130 and an outer edge 125 that borders the inner boundary of bevel zone 110.

According to an embodiment of the invention, each of progressive zone 130, bevel zone 110 and transition zone 120 may have a desired symmetry. For example, progressive zone 130, bevel zone 110 and transition zone 120 may be substantially concentric about vertical axis 111. The shape of the concentric progressive zone 130, transition zone 120, and bevel zone 110 may be generally circular, elliptical, or any other suitable shape. The concentric zones may be symmetric relative to vertical axis 111. This mold 100 may provide a more symmetric mold surface 102 than conventional molds provide. Thus, for example, a generally symmetric thin film may be positioned more evenly relative to mold 100 compared to a conventional mold.

As described above, the steepness along different regions of progressive zone 130 may vary, and consequently, the height along the outer boundary of progressive zone 130 may vary. Boundary points 113 and 117 may represent points along the boundary between transition zone 120 and the relatively steep region 135 and the relatively shallow region 133 of progressive zone 130, respectively. For example, in FIG. 2 boundary point 113 may be higher, relative to horizontal axis 115, than boundary point 117.

In some embodiments, bevel surface 112 may include surface indentations, for example, grooves for securing progressive mold 100 during casting.

According to an embodiment of the invention, the height of bevel surface 112, h3, may be substantially constant, for example, relative to horizontal axis 115. Bevel height, h3, may be greater or equal to the height of progressive surface 132 and transition surface 122 at any given point. In some embodiments, the outer boundary points of progressive zone 130, for example, boundary points 113 and 117, may have heights, h1 and h2, respectively, which may be less than the height, h3, of bevel surface 112. In another example, a boundary point 143 may represent a point along the boundary between bevel zone 110 and transition zone 120. In this example, the height of boundary point 143, along the outer edge 125 of transition zone 120, is equal to the height of bevel surface 112, i.e. h3.

Transition zone 120 may include a transition surface 122 of gradual transition between the curved progressive surface 132 and the generally level bevel surface 112. The inner edge 123 of transition surface 122 may provide a smooth surface where transition surface 122 and progressive surface 132 may meet. The outer edge 125 of transition surface 122, may provide a smooth and level surface where transition surface 122 and bevel surface 112 may meet. In one embodiment, the substantially smooth surface of transition zone 120, may contain no sharp edges or protrusions, and may be substantially continuously differentiable.

The height of transition surface 122 may vary gradually from h2 to h3. Since inner edge 123 of transition zone 120 borders the outer boundary of progressive zone 130, for example, at boundary points 113 and 117, which may vary in height as discussed above, the inner edge 123 of transition surface 122 may likewise vary in height. Since the outer edge 125 of transition zone 120 meets the inner boundary of bevel zone 110, for example, at boundary points 143, which as discussed above, may have constant height, h3, the outer edge 125 of transition zone 120 may have constant height. Transition surface 122 may vary in steepness to form a gradual incline between the outer boundary of progressive surface 132 with varying height, from h1 to h2, and the inner boundary of bevel surface 112 with constant height, h3. Transition surface 122 may have any substantially smooth transitional shape, in accordance with embodiments of the invention. In some embodiments, transition surface 122 may have limited, for example, minimal number of points of inflection, where the concavity of the surface changes from convex to concave, for example, along the radial meridian. In some embodiments, transition surface 122 may have one such point on each meridian.

Transition surface 122 may form a substantially gradual incline from progressive zone 130 to bevel zone 110. A substantially gradual incline may prevent mold 100 from having the steep inclines and/or nondifferentiable points of conventional molds, which may form castes of uneven thickness and/or with sharp edges. Since transition zone 120 provides a gradual transition towards flatness, transition zone 120 may be substantially shallower than progressive zone 130. For example, the average curvature along transition surface 122 may be shallower than the average curvature along progressive surface 132.

Transition surface 122 may be designed by interpolation between the outermost curvature of progressive surface 132 and the generally level bevel surface 112. Any suitable interpolation technique may be used, for example, Krigging interpolation.

Thin film 160 may be positioned for casting on mold 100 during a molding process according to some embodiments of the invention. Thin film 160 may be a thin lens having two surfaces, for example, a top surface 162 and a bottom surface 164. Top surface 162 and bottom surface 164 may both be spherical and may have the same curvature at corresponding locations. Thin film 160 may be positioned on progressive mold 100 prior to the casting process. The casting material, for example, a plastic material, may be poured onto thin film 160 and mold 100. Thin film 160 may become engulfed by the casting material, such that there may be no spacing between thin film 160 and the casting material. Thin film 160 may be made of materials such as, plastics, photo chromatic materials, polarized materials or any other suitable material.

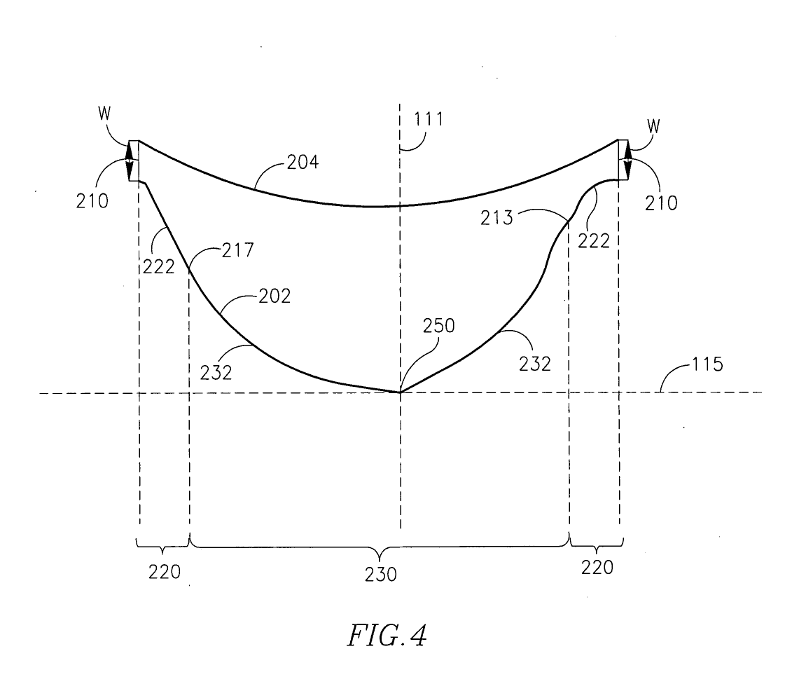

Reference is made to FIG. 4, which schematically illustrates a cross-sectional side view of a caste 200 formed using mold 100 according to embodiments of the invention. Caste 200 may be formed during a casting process, for example, using elements depicted in FIG. 2. Caste 200 may be, for example, a progressive lens, a SFB, or any other caste produced using a progressive mold such as, for example, mold 100, shown in FIG. 2 and FIG. 3. Caste 200 may be made of any suitable casting material or combination of materials, for example, plastic, photo chromatic material, polarized material, or thin films. Lens 200 may include one or more thin films that may be engulfed or embedded into the caste during a casting process, according to embodiments of the present invention. Caste 200 may be modified during or after casting in any suitable way, for example, by tooling, finishing, or polishing.

Caste 200 may include a front surface 202 and a back surface 204. Back surface 204 may be substantially spherical. Front surface 202 may correspond to mold surface 102. Front surface 202 of caste 200 may include an imprint of a portion of mold surface 102 of mold 100, for example, the progressive zone 130 and transition zone 120 shown in FIG. 2. In general, the bevel zone 110 is not caste. Bevel zone 110 may be used to hermetically seal the mold to a gasket during casting. Front surface 202 may include progressive caste surface 232 of progressive caste zone 230 and transition caste surface 222 of transition caste zone 220. Each region of front surface 202 may have different properties. In one embodiment, progressive caste zone 230 may be wider than transition caste zone 220.

Lens 200 may include lens center 250 that may correspond to center point 150 of progressive mold 100. Lens center 250 may be a most protrusive point on the progressive caste zone. Caste center 250 may be the center point of progressive caste region 232 and transient caste region 222. A vertical axis 111 and a horizontal axis 115 may have their origins at caste center 250.

Progressive caste surface 232 may correspond to progressive surface 132 and transition caste surface 222 may correspond to transition surface 122. Each zone of front surface 202 may have substantially similar surface properties to the corresponding zone of mold surface 102 from which they were caste. Transition caste zone 220 may surround progressive caste zone 230. Progressive caste zone 230 and transition caste zone 220 may be generally concentric about vertical axis 111.

Progressive caste surface 232 may be the innermost region of front surface 202. Progressive caste zone 230 may be centered at center point 250. Progressive caste surface 232 may be generally convex and may have variable curvature. Progressive caste zone 230 may include progressive optical properties.

Since the curvature of progressive caste surface 232 may vary, a height along an outer boundary of progressive caste zone 230 may vary. Boundary points 213 and 217 may represent points along the boundary between transition caste zone 220 and progressive caste zone 230. In some embodiments, boundary point 213 may be higher, relative to horizontal axis 115, than boundary point 217.

Transition caste surface 220 may provide a substantially smooth transition from the outer boundary of progressive caste zone to an outer edge 210 of caste 200. In some embodiments, transition caste surface 222 may have limited, for example, minimal number of points of inflection, where the concavity of the surface changes from convex to concave, for example, along the radial meridian. In some embodiments, transition surface 122 may have one such point on each meridian.

Referring briefly back to FIG. 2, since outer edge 125 of transition zone 120 may have constant height, h3, it will be appreciated by a person skilled in the art that the outer edge 210 of the resultant caste 200 may have a constant thickness, w.

The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

1. A progressive mold comprising:
an inner progressive zone having one or more progressive optical properties;
an outer bevel zone; and
a transition zone in between the progressive and bevel zones to form a generally smooth transition between the progressive zone and the bevel zone.

2. The mold of claim 1, wherein the bevel zone has a substantially constant width.

3. The mold of claim 2, wherein the bevel zone has a substantially constant height.

4. The mold of claim 1, wherein the transition zone provides a gradual transition in surface curvature between the progressive zone and the bevel zone.

5. The mold of claim 1, wherein the progressive zone, transition zone and bevel zone are substantially concentric about a common axis.

6. The mold of claim 5, wherein said axis is defined through a lowest point on the progressive zone.

7. The mold of claim 2, having a substantially continuously differentiable surface.

8. A progressive caste comprising a progressive caste zone having one or more progressive optical properties, wherein an outer edge of the caste has a substantially constant thickness.

9. The progressive caste of claim 8 comprising a transition caste zone surrounding the progressive caste zone, to provide a substantially smooth transition from the progressive caste zone to the outer edge of the caste.

10. The progressive caste of claim 8, wherein the progressive caste zone and the transition caste zone are substantially concentric about a common axis.

11. The progressive caste of claim 10, wherein said axis is defined through a maximally protrusive point on the progressive caste zone.

12. The progressive caste of claim 9, wherein the progressive caste zone and the transition caste zone form a substantially smooth surface of varying curvature.

13. The progressive caste of claim 8, wherein the progressive caste zone and the transition caste zone form a substantially continuously differentiable surface.

14. The progressive caste of claim 8 comprising a thin film, which is embedded in the caste.

15. The progressive caste of claim 8 comprising a plastic material.

16. The progressive caste of claim 9, wherein the progressive caste zone is wider than the transition caste zone.
